(19) United States
(12) Patent Application Publication
(10) Pub. No.: US 2009/0119374 A1
(43) Pub. Date: May 7, 2009

(54) ADAPTIVE INSTANT MESSAGING AWARENESS

(75) Inventors: Patrick J. O'Sullivan, Dublin (IE); Hema Srikanth, Cary, NC (US); Carol S. Zimmet, Boxborough, MA (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 11/934,849

(22) Filed: Nov. 5, 2007

(51) Int. Cl. G06F 15/16

(52) U.S. Cl. 709/206

(57) ABSTRACT

Embodiments of the present invention address deficiencies of the art in respect to presence awareness for instant messaging and provide a novel and non-obvious method, system and computer program product for adaptive instant messaging awareness. In an embodiment of the invention, a method for adaptive instant messaging awareness can be provided. The method can include overriding an instant messaging system presence awareness do not disturb state for a user of an instant messenger in the instant messaging system in response to determining a contemporaneously calendared event for the user.

### BACKGROUND OF THE INVENTION

1. Field of the Invention

The present invention relates to the field of instant messaging and more particularly to presence awareness for instant messaging.

2. Description of the Related Art

Electronic mail, referred to in the art as e-mail, has proven to be the most widely used computing application globally. Though e-mail has been a commercial staple for several decades, due to the explosive popularity and global connectivity of the Internet, e-mail has become the preferred mode of asynchronous communications, regardless of the geographic separation of communicating parties. Today, more e-mails are processed in a single hour than phone calls. Clearly, e-mail as an asynchronous mode of communications has been postured to replace all other modes of communications excepting voice telephony.

In contrast to the asynchronous nature of e-mail, the recent rapid development of the Internet has led to advanced modes of synchronous, real-time collaboration able to fulfill the real-time communicative requirements of the modern computing participant. Using the Internet as a backbone, individuals worldwide can converge in real-time in cyberspace to share ideas, documents and images in a manner not previously possible through conventional telephony and video conferencing. To facilitate collaboration over the Internet, a substantial collection of synchronous messaging technologies and protocols have been assembled to effectively deliver audio, video and data over the single data communications medium of the Internet. These synchronous messaging technologies include several, real-time human-to-human collaborative environments such as instant messaging and persistent chat rooms.

In the conventional instant messaging and chat environment, different collaborators can engage in a real-time exchange of messages including text messages, graphical information and even audiovisual information in a common messaging space. The common messaging space can accommodate a pair of conversants to a chat, or multiple conversants to a conference. In some circumstances, the initiation of the chat can be spontaneous upon one conversant recognizing the presence and availability of a partner conversant. In other circumstances, the initiation of the chat can be planned and can even subsist in a calendared event in a calendaring and scheduling system.

Conventional instant messengers rely upon presence awareness in assisting users with the establishment of a chat session with other users. Presence awareness refers to the ability of the instant messaging system to determine when a user is available to engage in a chat session. Generally, presence awareness can be manually established by each user through a selection of a number of states ranging from “I am available” to “Away from computer” to “Do Not Disturb”. Alternatively, presence awareness can be established automatically by sensing activity in a computer. Idleness past a threshold duration of time can be indicative to the absence of a user and the state of the user can be set by the presence awareness logic of the instant messaging system accordingly.

Situations oftentimes arise where one individual intends to contact another individual through instant messaging, but cannot establish contact as the other individual is in a “Do Not Disturb” state. This can be particularly frustrating if individuals are geographically separated—where it is not possible to physically locate the other individual in person. The problem of locating a desired albeit unavailable conversant can be compounded where the desired conversant had been scheduled to participate in a calendared event, such as an appointment, task, e-meeting or even a conference call. To the extent that the desired conversant is critical to the conduct of the calendared event, locating the desired conversant can be of paramount importance. Yet, though the desired conversant may be physically present somewhere in the office building, the inability to contact the desired conversant in such circumstances can injure productivity through failed or canceled events and lost time in establishing an audience for the event.

### BRIEF SUMMARY OF THE INVENTION

Embodiments of the present invention address deficiencies of the art in respect to presence awareness for instant messaging and provide a novel and non-obvious method, system and computer program product for adaptive instant messaging awareness. In an embodiment of the invention, a method for adaptive instant messaging awareness can be provided. The method can include overriding an instant messaging system presence awareness do not disturb state for a user of an instant messenger in the instant messaging system in response to determining a contemporaneously calendared event for the user.

In an aspect of the embodiment, the method also can include establishing a trust relationship with a calendaring and scheduling application, exposing an interface to override a do not disturb state for a user of the instant messaging system, and accepting a directive from the calendaring and scheduling application through the interface to override a do not disturb state for the user. In another aspect of the embodiment, the method also can include reverting the instant messaging system presence awareness do not disturb state for the user of the instant messenger in the instant messaging system in response to determining a passage of the contemporaneously calendared event for the user.

In another embodiment of the invention, an instant messaging data processing system can be provided. The system can include multiple different instant messaging clients coupled to an instant messaging server over a computer communications network. The system further can include a calendaring and scheduling application. Yet further, the system can include adaptive instant messaging awareness logic executing in a computing system and coupled to the calendaring and scheduling application and at least one of the instant messaging server and the instant messaging clients. The logic can include program code enabled to override a presence awareness do not disturb state for a user of one of the instant messengers in response to determining a contemporaneously calendared event for the user in the calendaring and scheduling application. For instance, the calendared event can be an appointment, a task or a meeting.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for adaptively managing presence awareness in an instant messaging system;

FIG. 2 is a schematic illustration of an instant messaging system configured for adaptive presence awareness; and,

FIG. 3 is a flow chart illustrating a process for adaptively managing presence awareness in an instant messaging system.

### DETAILED DESCRIPTION OF THE INVENTION

Embodiments of the present invention provide a method, system and computer program product for adaptively managing presence awareness in an instant messaging system. In accordance with an embodiment of the present invention, presence awareness can be applied to users of an instant messaging system and from time to time, individual ones of the users can select a do not disturb status for presence awareness. However, when a calendar event for the user is detected as contemporaneously scheduled, the do not disturb status can be overridden for the user so as to allow other users to contact the user in respect to the contemporaneously scheduled calendar event.

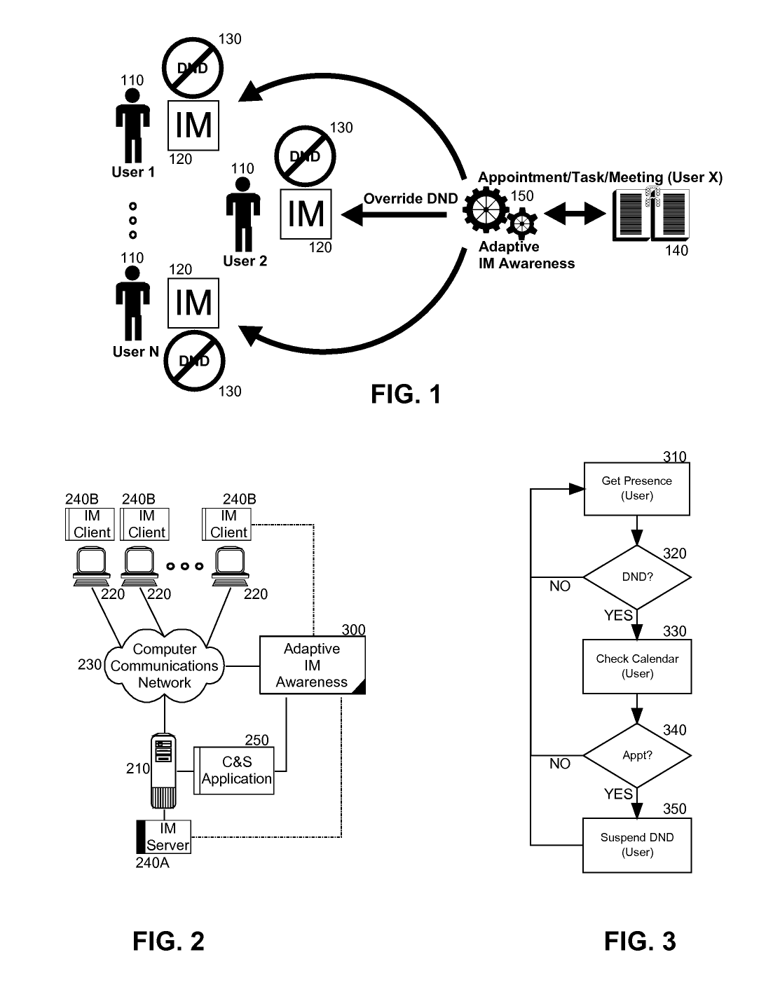

In further illustration, FIG. 1 is a pictorial illustration of a process for adaptively managing presence awareness in an instant messaging system. As shown in FIG. 1, multiple different users 110 can communicate with one another through respective instant messengers 120. The different instant messengers 120 can be included as part of an instant messaging system and can support presence awareness. In this regard, each of the users 110 can establish a do not disturb state 130 when desired. Even still, adaptive instant messaging awareness logic 150 can override the do not disturb state 130 for a given one of the users 110 when a corresponding event in calendaring and scheduling application 140 indicates the temporal proximity of an appointment, task, or meeting as the case may be. In this way, a user 110 in a do not disturb state 130 contemporaneously scheduled to participate in a calendared appointment, task, or meeting can be reached just the same through a respective instant messenger 120.

The process shown in FIG. 1 can be embodied within an instant messaging data processing system. To that end, FIG. 2 is a schematic illustration of an instant messaging system configured for adaptive presence awareness. The system can include a host server 210 configured for communicative coupling to one or more clients 220 over computer communications network 230. The host server 210 can support the operation of an instant messaging server 240A managing instant messaging sessions amongst instant messaging clients 240B, each hosted within a corresponding one of the clients 220.

Notably, adaptive instant messaging awareness logic 300 can be coupled to the instant messaging server 240A, the instant messaging clients 240B, or both. The adaptive instant messaging awareness logic 300 further can be coupled to a calendaring and scheduling application 250 resident in the instant messaging server 240A, instant messaging clients 240B or both. The calendaring and scheduling application 250 can include a personal information manager, groupware, or any application that provides for scheduled events such as tasks, appointments, meetings and the like for specified users. The adaptive instant messaging awareness logic 300 can include program code enabled to override a do not disturb state in the instant messaging server 240A, the instant messaging clients 240B, or both for a particular user in response to determining the contemporaneous scheduling of an event for the particular user.

Optionally, a relationship of trust can be specified for different calendaring and scheduling applications 250 coupled to the adaptive instant messaging awareness logic 300 such that once trusted, a calendaring and scheduling application 250 can invoke the program code of the adaptive instant messaging awareness logic 300 in order to override the do not disturb state for a particular user. In this regard, the adaptive instant messaging awareness logic 300 can expose an interface to the calendaring and scheduling application 250 through which the calendaring and scheduling application 250 when trusted can invoke the adaptive instant messaging awareness logic 300 to override the do not disturb state for a specified user. In any case, once the contemporaneous nature of a triggering event has passed, the presence awareness state for the particular user can revert to a do not disturb state.

In yet further illustration of the operation of the adaptive instant messaging awareness logic 300, FIG. 3 is a flow chart illustrating a process for adaptively managing presence awareness in an instant messaging system. Beginning in block 310, the presence awareness state for a user can be identified and in decision block 320, it can be determined whether or not the user is in a do not disturb state. If so, in block 330 the calendar for the user can be consulted to determine whether or not a calendared event has been contemporaneously scheduled. In decision block 340, if it is determined that a calendared event has been contemporaneously scheduled for the user, in block 350 the do not disturb state for the user can be lifted and an available state can be specified for the user. Optionally, the do not disturb state for the user can be lifted only in respect to a selected group of users, for example a group of users scheduled also to participate in the scheduled event. For other users, the do not disturb state can remain.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. An adaptive instant messaging awareness method comprising overriding an instant messaging system presence awareness do not disturb state for a user of an instant messenger in the instant messaging system in response to determining a contemporaneously calendared event for the user.

2. The method of claim 1, wherein determining a contemporaneously calendared entry for the user comprises determining a contemporaneously calendared event for the user selected from the group consisting of an appointment, a task and a meeting.

3. The method of claim 1, further comprising:
establishing a trust relationship with a calendaring and scheduling application;
exposing an interface to override a do not disturb state for a user of the instant messaging system; and,
accepting a directive from the calendaring and scheduling application through the interface to override a do not disturb state for the user.

4. The method of claim 1, further comprising reverting the instant messaging system presence awareness do not disturb state for the user of the instant messenger in the instant messaging system in response to determining a passage of the contemporaneously calendared event for the user.

5. The method of claim 1, wherein overriding an instant messaging system presence awareness do not disturb state for a user of an instant messenger in the instant messaging system in response to determining a contemporaneously calendared event for the user, comprises overriding an instant messaging system presence awareness do not disturb state for a user of an instant messenger in the instant messaging system in response to determining a contemporaneously calendared event for the user, only in respect to a selected group of users scheduled to participate in the contemporaneously calendared event.

6. An instant messaging data processing system comprising:
a plurality of instant messaging clients coupled to an instant messaging server over a computer communications network;
a calendaring and scheduling application; and,
adaptive instant messaging awareness logic executing in a computing system and coupled to the calendaring and scheduling application and at least one of the instant messaging server and the instant messaging clients, the logic comprising program code enabled to override a presence awareness do not disturb state for a user of one of the instant messengers in response to determining a contemporaneously calendared event for the user in the calendaring and scheduling application.

7. The system of claim 6, wherein the calendared event is an event selected from the group consisting of an appointment, a task and a meeting.

8. A computer program product comprising a computer usable medium embodying computer usable program code for adaptive instant messaging awareness, the computer program product comprising computer usable program code for overriding an instant messaging system presence awareness do not disturb state for a user of an instant messenger in the instant messaging system in response to determining a contemporaneously calendared event for the user.

9. The computer program product of claim 8, wherein the computer usable program code for determining a contemporaneously calendared entry for the user comprises computer usable program code for determining a contemporaneously calendared event for the user selected from the group consisting of an appointment, a task and a meeting.

10. The computer program product of claim 8, further comprising:
computer usable program code for establishing a trust relationship with a calendaring and scheduling application;
computer usable program code for exposing an interface to override a do not disturb state for a user of the instant messaging system; and,
computer usable program code for accepting a directive from the calendaring and scheduling application through the interface to override a do not disturb state for the user.

11. The computer program product of claim 8, wherein the computer usable program code for overriding an instant messaging system presence awareness do not disturb state for a user of an instant messenger in the instant messaging system in response to determining a contemporaneously calendared event for the user, comprises computer usable program code for overriding an instant messaging system presence awareness do not disturb state for a user of an instant messenger in the instant messaging system in response to determining a contemporaneously calendared event for the user, only in respect to a selected group of users scheduled to participate in the contemporaneously calendared event.

12. The computer program product of claim 8, further comprising computer usable program code for reverting the instant messaging system presence awareness do not disturb state for the user of the instant messenger in the instant messaging system in response to determining a passage of the contemporaneously calendared event for the user.
